(19) United States
(12) Patent Application Publication
(10) Pub. No.: US 2005/0236317 A1
(43) Pub. Date: Oct. 27, 2005

(54) Pendant drop control in a multiwell plate

(75) Inventors: Kenneth Desilets, Westford, MA (US); Marc Richard Emerick, Rye, NH (US); Christopher A. Scott, Westford, MA (US); Steven D. Sheridan, Wakefield, MA (US)

Correspondence Address: MILLIPORE CORPORATION, 290 CONCORD ROAD, BILLERICA, MA, 01821, US

(73) Assignee: Millipore Corporation, Billerica, MA (US)

(21) Appl. No.: 11/062,113

(22) Filed: Feb. 18, 2005

Related U.S. Application Data
(60) Provisional application No. 60/565,001, filed on Apr. 23, 2004.

(51) Int. Cl. B01D 25/02

(52) U.S. Cl. 210/323.1; 422/101; 422/99; 210/248; 210/498

(57) ABSTRACT

The present invention relates to a multiwell filtration plate system formed of a multiwell filter plate, an underdrain, preferably having spouts as the outlet from the underdrain and a collection device such as a collection plate and the use of a mechanical device such as a fixture in the form of a post, a ramp, a rib, a spout protector ring and the like formed in the collection plate wells or on the outside of the underdrain or both for contacting a forming pendant drop formed on the spout of the underdrain and transferring it to the collection plate well.

### CROSS REFERENCE RELATED APPLICATIONS

This application claims the benefit of U.S. Provisional Application No.: 60/565,001, filed on Apr. 23, 2004.

### BACKGROUND OF THE INVENTION

The use of multiwell plates to filter and purify various products such as proteins, DNA, RNA, plasmids and the like or for use in drug screening or drug discovery in the laboratory is widespread and growing. The advantages are many. The ability to use small volumes of samples required especially with experimental compounds or with the screening of 1000s of potential compounds reduces cost. The ability to run multiple samples at the same time reduces time and cost.

Most plate-based systems are arranged to have a filter plate positioned above a collection device such as a collection plate. A typical system is shown in FIG. 1. The filter plate 2 has a series of wells 4, typically 96 or 384 or 1536 arranged in orderly rows and columns. The bottom 6 of each well 4 has an opening 8 that is selectively closed by one or more filters or membranes 10. The collection device, here shown as a plate 12 typically has the same number of wells 14 as the filter plate and they are aligned with those of the filter plate so that they collect the fluid from the respective well above it. The bottom 16 of the wells 14 of the collection plate 12 are generally closed as shown or they may be open if desired.

All fluid in the filter plate must pass through the filter or membrane 10 before reaching the collection plate well 14. Most filter plates 2 also contain an underdrain 18 below the filter or membrane 10. The underdrain 18 contains an opening at its lower end and that opening generally contains a spout 20 to direct the fluid from the filter plate 2 to the well 14 of the collection plate 12 below it. The spout 20 also acts to hold back fluid flow through it when it is subject to simple atmospheric pressure. Flow occurs with aqueous based fluids only when a sufficient pressure differential, such as a vacuum is applied to the system. It also contains some type of sloped surface 21 to cause the fluid in the underdrain 18 to move toward the spout 20.

In practice, the system is assembled and placed on a vacuum manifold. The vacuum draws the fluid through the filter plate and underdrain and into the collection plate. However, some fluid remains behind after the filtration has been completed. Typically, this fluid is found in the underdrain and as a pendant drop extending downward from the spout opening.

Several problems exist with leaving some sample behind.

For smaller volume application such as 384 and 1536 well systems (these systems include that number of wells on a plate that is equal in area to that used for a 96 well plate, meaning that the well size and sample size respectively 4× and 16× smaller than that of a 96 well plate system) the loss of sample can amount to 10 to 20% of the entire sample.

For all multiwell systems, the fluid in the pendant drops can often migrate to adjacent wells along adjacent surfaces or the pendant drops can be transferred to an adjacent well when the plates are taken apart to obtain the material in the collection plate. This leads to cross contamination of the sample and reduces the reliability of the system and the test that has been run. Likewise, many systems run sequential steps in the same system. The residual material can either then be present in the second step collection sample which is undesirable or it can over time migrate back or wick back through the filter or membrane and be present in the well of the filter plate from which it was removed. If for example the first step was a desalting step to remove salts or primers or other chemicals from a sample, this leads to a less pure sample and may complicate the second or later steps performed upon it. Additionally, when the filter plate is removed from the manifold, any pendant drops tend to rain down on the collection plate, equipment and adjacent laboratory surfaces and thereby contaminating them.

Several approaches have been made to resolve the issue of pendant drop formation.

U.S. Pat. No. 4,902,481 uses a specially designed spout configuration having a collar which extends in a direction perpendicular to the vertical axis of the spout so that the collar and spout outer surface prevent pendant drop migration and direct any pendant drops into the collection well.

It however merely controls the pendant drop's lateral movement, not its formation or its migration into the collection plate.

In U.S. Pat. No. 4,526,690 the use of a hydrophobic porous layer at the bottom of each well prevented pendant drops from forming. However, when sufficient pressure is applied to the system the liquid overcomes the hydrophobic resistance and flows through the membrane to the collection plate. Additionally, the use of a separate grid of drop guiding projections, arranged between the two plates, is used to pull any drops that are formed along its surfaces and into the collection well.

In many applications the use of a hydrophobic membrane is not suitable. Even when they may be suitable, the vacuum required is higher than normally used, as it needs to overcome the phobic resistance of the filter.

Likewise, the use of the separate grid with the hydrophobic system has not proven to be successful. Plates by different manufacturers can vary in their dimensions making such grids often plate specific. Additionally and more importantly, many plates are handled robotically and the introduction of a component that is loose and not easily gripped by robotic arms is not acceptable. Additionally, robotics are not exact and their handling often leads to overcompression of the plates which in turn leads to puncturing of the membrane by the grids which is unacceptable. To date no commercial embodiment of this design has been introduced.

US 2002/0179520A1 and 2002/0150505A1 use a normal plate system and moves the top plate relative to the collection plate before they are completely pulled apart so as to cause any pendant drops to touch off on one or more walls of the collection wells. Preferably, this is accomplished by a movement of both plates relative to each other in a first and then in an opposite direction so there are two touch off attempts.

This idea requires specialized robotic equipment to create the relative movement between the plates. Additionally, the plate dimensions and movements need to be tightly controlled in order to ensure that the spout moves sufficiently close to the first and optimally the second wall of the well to create the touch off function while not moving the spout too close to cause an actual touching which could potentially damage the plate system.

U.S. Pat. No. 5,108,704 teaches the formation of a unique filter plate design in which the spout is located at an edge of the well beyond the point below the active filter area. The spout is designed to mate with the wall of the collection plate so that no drop is formed and all liquid flows down the wall. For plates with more than 96 wells (e.g. 384) there is not enough room on the standard plate size (as defined by the American National Standards Institute/Society for Biological Standards (ANSI/SBS) which sets industry standards for among other things, device sizes including multiwell plate dimensions standards), for the spout to be outside the active membrane area and still conform to the ANSI/SBS plate dimensions standard. This limits that plate's applicability and application.

This product has not been successfully commercialized. It requires the use of a new plate design. Moreover it requires that both the filter plate and the collection plate be made to high tolerances in order to create the exact fit required. Such a device is not acceptable in robotic applications as well as the robots don't have the fine control necessary to mate and detach the plates. As such they would be continuously jammed and/or damaged making them useless.

What is desired is a device that provides the advantages of the current multiwell plate system but which reduces or eliminates the issue of pendant drops or at the very least controls them and which is robotically friendly. Moreover, it is desired to have a device that provides consistent pendant drop removal across the length and breadth of the plate. The present invention provides such a system.

### SUMMARY OF THE INVENTION

The present invention relates to a multiwell plate having pendant drop control. More particularly, it relates to a multiwell plate having a device located adjacent an opening in its bottom located so as to provide pendant drop control into the collection plate downstream of the opening.

The present invention provides a mechanical means for controlling and directing the formation of pendant drops emanating from the underdrain openings such that the formed drops touch-off on a downstream feature(s) on the underdrain and/or collection device and release from the filter system. The present idea achieves this by either forming the pendant drops near the touch-off feature, or by creating a means to form and then migrate the drops towards the touch-off feature. For certain underdrain designs and at higher flow rates, liquid is emitted from the underdrain opening as a stream, rather than drop-wise. However, when flow stops, static pendant drops will hang on the openings with size and shape dependent on opening design, material, operating conditions, and other factors. The present idea is novel in removing these static pendant drops independent of these design, material, and operating conditions.

The present invention relates to a multiwell filtration plate system formed of a multiwell filter plate, an underdrain attached to the bottom of the filter plate, the underdrain having openings as the outlet from the underdrain and a collection device located below the underdrain. More particularly it relates to the use of a mechanical device such as a fixture in the form of a post, a ramp, a rib, a spout ring and the like formed in either the collection device or on the outside of the underdrain or both for contacting a forming pendant drop formed on the opening of the underdrain and transferring it to the collection device.

It is an object of the present invention to provide a multiple well plate filtration system comprising a filter plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface, a bottom surface and a thickness in between, the top surface of the underdrain attached to the bottom of the plate, the underdrain having a series of chambers formed in its thickness that register and mate with the bottom of the plurality of wells of the plate so as to ensure that fluid passing through the filter of a selected well enters only the respective chamber of the underdrain, each chamber having an opening through the bottom surface of the underdrain to an outside environment, a collection device located below the underdrain, the collection device having a top, a bottom and a thickness between the top and the bottom and a means for collecting fluid from the opening of the underdrain and a mechanical device for directing the fluid from the opening of the underdrain into the collection device said device being located on a surface selected from the group consisting of the underdrain, the collection device and both the underdrain and the collection device.

It is another object of the present invention to provide a fixture in the collection device for transferring the pendant drops from the underdrain opening to the associated collection device.

It is a further object of the present invention to provide a fixture on the outside of the underdrain for transferring the pendant drops from the opening to the associated collection device.

It is another object of the present invention to provide a fixture in the collection device and on the underdrain for transferring the pendant drops from the underdrain opening to the associated collection device.

### BRIEF DESCRIPTION OF THE DRAWINGS

FIG. 1 shows the plate system of the prior art.

FIG. 2 shows a collection device in cross-sectional view according to one embodiment of the present invention in use with a filter plate and underdrain.

FIG. 3 shows a cross-sectional view of one well of a collection device according to one embodiment of the present invention.

FIG. 4 shows a cross-sectional view of one well of a collection device according to another embodiment of the present invention.

FIG. 5 shows a cross-sectional view of one well of a collection plate according to an additional embodiment of the present invention.

FIG. 6 shows a cross-sectional view of an underdrain according to one embodiment of the present invention.

FIG. 7 shows a cross-sectional view of an underdrain according to an additional embodiment of the present invention.

FIG. 8 shows a cross-sectional view of an underdrain according to further embodiment of the present invention.

FIG. 9 shows a cross-sectional view of an underdrain according to another embodiment of the present invention.

FIG. 10 shows a cross-sectional view of an underdrain according to a further embodiment of the present invention.

FIG. 11 shows a cross-sectional view of an underdrain according to a further embodiment of the present invention.

FIG. 12 shows a cross-sectional view of an underdrain according to a further embodiment of the present invention.

FIG. 13 shows a cross-sectional view of an underdrain according to a further embodiment of the present invention.

FIG. 14 shows a cross-sectional view of another embodiment of the present invention.

FIG. 15 shows a cross-sectional view of another embodiment of the present invention.

FIG. 16 shows a cross-sectional view of another embodiment of the present invention.

FIG. 17 shows a cross-sectional view of another embodiment of the present invention.

FIG. 18 shows a cross-sectional view of another embodiment of the present invention.

FIG. 19 shows a cross-sectional view of another embodiment of the present invention.

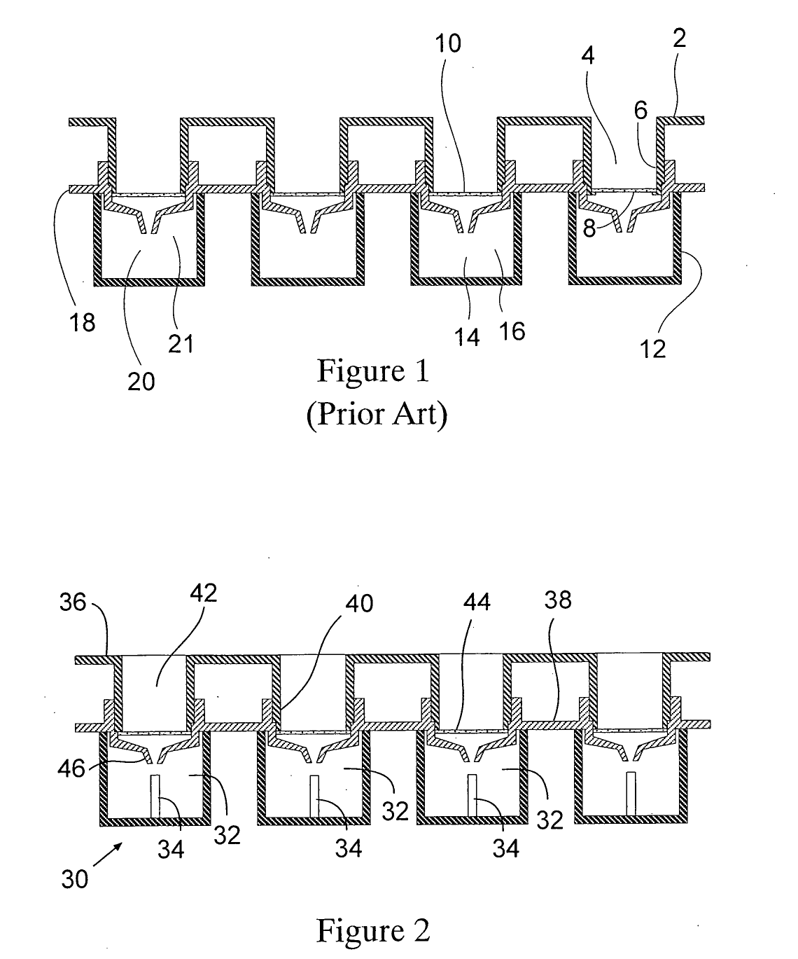

### DETAILED DESCRIPTION OF THE INVENTION

The present invention relates to a multiwell filtration plate system that controls pendant formation. The system includes as a minimum either a collection device such as a collection plate with one or more wells and with an open or closed bottom to the one or more wells, a second filter plate, a wicking structure such as a series of grids or ribs arranged below the openings of the device above or any other such device used with such filter plates to collect and/or transfer fluid from the filter plate downstream either to waste, a common collection point or individual filtrate wells or an underdrain for a filter plate wherein the collection device or underdrain or both (respectively) have a mechanical device formed on it or in it to cause the removal of pendant drops and to transfer them to a collection device. Preferably, the system comprises an underdrain and a collection device containing one or more wells below the underdrain wherein either the underdrain and/or the collection device has mechanical device formed in it or on it to transfer a pendant drop to the collection device.

Most preferably, the system includes the filtration plate, the underdrain and a collection device in the form of a collection plate (with or without a closed bottom) wherein either the underdrain and/or the collection plate has mechanical device formed in it or on it to transfer a pendant drop to the one or more collection plate wells. While most embodiments will be discussed in relation to a collection plate, it is meant to cover and include other collection devices as well.

FIG. 2 shows a first embodiment of the present invention. In this embodiment, the collection plate 30 is formed of multiple individual wells 32 that are isolated from each other. A mechanical device 34 is formed in each well 32. Also shown in this embodiment are a filter plate 36 and an underdrain 38 attached to the bottom 40 of the filter plate 36 which work in cooperation with the invention herein. The filter plate 36 is formed of a series of individual wells 42 that are isolated from each other and are equal in number and in register with the wells 32 of the collection plate 30 of the invention in this embodiment. The bottom of each well 42 has a filter 44 attached to it in a manner well known in the art so that all fluid passing through the bottom of the filter plate 36 well must first pass through the filter 44. The underdrain 38 is attached is to the bottom 40 of the filter plate 36. It may be a separate item that is attached by friction fit, glues, adhesives, welds or mechanical means such as screws, clamps, clips and the like. Alternatively, it may be an integral part of the filter plate having been formed as part of it or as a secondary molded addition. The mechanical device 34 formed in the collection plate wells 32 is designed to collect any pendant drop that may form on the opening of the underdrain, in this embodiment shown as a spout 46 of during filtration.

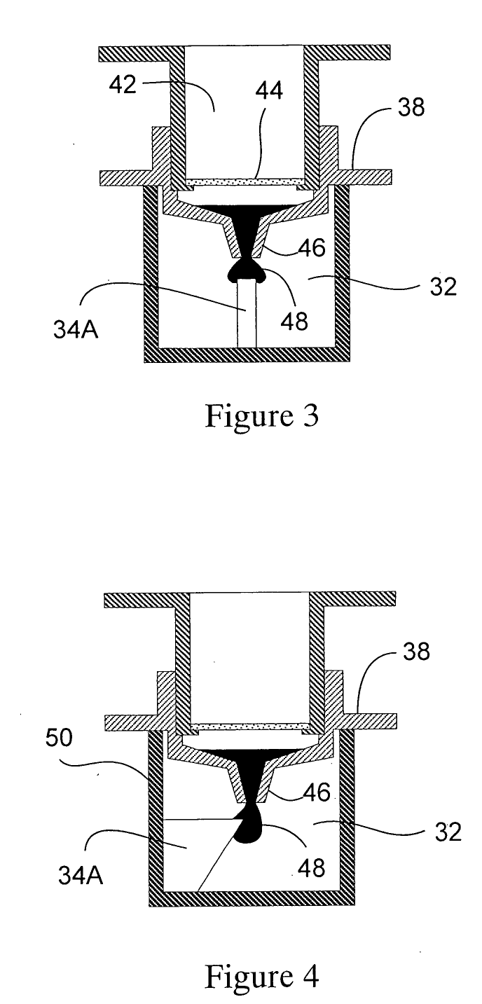

FIG. 3 shows a close up view of one well of the collection plate according to the first embodiment of the invention along with the ancillary underdrain and filter plate. The mechanical device 34, in this embodiment in the form of a post, is located below the spout 46 and separated by a distance sufficient to allow a pendant drop 48 to at least partially form and to avoid any potential of hitting the post 34 by the spout 46 of an underdrain during assembly or use. This distance can be as little as 0.001 inch (0.0254 mm) and can be up to about the size of the pendant drop formed by that particular spout size. Preferably, it is somewhere in between the two. More preferably, it is at a distance sufficient to allow for the drop 48 to partially form before it contacts the device 34. In this way, the device 34 and underdrain 38 are clear of each other and not subject to damage and the liquid from the spout 46 is effectively pulled into the collection plate well 32 by contact with the device 32. While the head or top of the post 34 is shown to be flat it may be tapered, rounded or made into any other form that is useful for transferring the fluid. Additionally, while the post 34 is shown to be formed in the bottom of the collection plate, it could also be formed as part of the inner wall and extend outwardly either on an angle or horizontally from the wall.

FIG. 4 shows a close up view of one well of the collection plate according to a second embodiment of the invention along with the ancillary underdrain and filter plate. The mechanical device 34A, in this embodiment in the form of a ramp, extends out from at least a portion of the inner wall 50 of the collection plate well 32 such that its greatest length is located below the spout 46. As in the first embodiment, it 34A is separated by a distance sufficient to allow a pendant drop 48 to at least partially form and to avoid any potential of hitting the ramp 34A by the spout 46 of an underdrain during assembly or use. This distance can be as little as 0.001 inch (0.0254 mm) and can be up to about the size of the pendant drop formed by that particular spout size. Preferably, it is somewhere in between the two. More preferably, it is at a distance sufficient to allow for the drop 48 to partially form before it contacts the device 34A. In this way, the device 34A and underdrain 38 are clear of each other and not subject to damage and the liquid from the spout 46 is effectively pulled into the collection plate well 32 by contact with the device 34A. Additionally, while the ramp 34A is shown to be formed in the bottom of the collection plate, it could also be formed as part of the inner wall and extend outwardly either on an angle or horizontally from the wall.

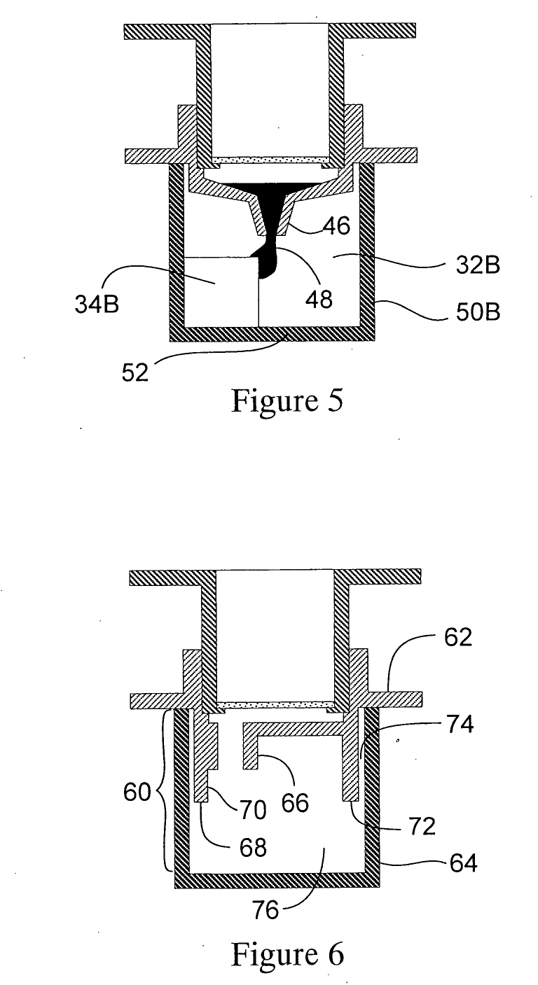

FIG. 5 shows a close up view of one well of the collection plate according to a third embodiment of the invention along with the ancillary underdrain and filter plate. The mechanical device 34B, in this embodiment in the form of a rib, is formed against the inner wall 50B of the well 32 and is located off center of and below the spout 46 by a small distance that is equal to or less than the radius of the pendant drop 48 that can be formed by the selected spout 46. Unlike the other first two embodiments, the rib 34B need not be of a shorter length than the distance between the spout 46 and the bottom 52 of the well 32 so long as it does not interfere with the fit or function of the system. The lateral distance by which the rib 34B is offset from the center of the spout 46 is sufficient to allow a pendant drop 48 to at least partially form and to avoid any potential of hitting the rib 34B by the spout 46 of an underdrain during assembly or use. This distance can be as little as 0.001 inch (0.0254 mm) and can be up to about the radius of the pendant drop 48 formed by that particular spout 46. Preferably, it is somewhere in between the two. More preferably, it is at a distance sufficient to allow for the drop 48 to partially form before it contacts the device 34B. By one method, this can be from about 0.05 R (where R=radius of the pendant drop formed) to about less than 1 R. Alternatively, by another method, this can be from about 0.05 R to about less about 1 R where R is the radius of the filter plate well or the collection plate well. In this way, the device 34B and underdrain 38 are clear of each other and not subject to damage and the liquid from the spout 46 is effectively pulled into the collection plate well 32 by contact with the device 34B.

FIG. 6 shows another embodiment of the present invention wherein the mechanical device 60 is formed as part of the underdrain 62 rather than as part of the collection plate 64. In this embodiment, the spout 66 is set off center and close to if not against the inner wall 70 of the protection ring 68 (as shown). While shown as a single piece, it may also be formed of two or more sections with gaps in between each adjacent section if desired. A pendant drop that is formed on the spout 66 will contact the inner wall of the collection ring and travel along it to it lower edge 72 where it will reform a pendant drop. The protection ring 68 outer wall 74 has a diameter smaller than the inner diameter of the collection plate well 76 in which it sits. The distance between the outer diameter of the ring 68 and the inner wall diameter of the well 76 is sufficient to allow a pendant drop to at least partially form, to allow for easy fit between the components even when applied together robotically and to avoid any potential of hitting the ring 68 by the well wall 74 during assembly or use. This distance can be as little as 0.001 inch (0.0254 mm) and can be up to about the radius of the pendant drop formed by that particular ring's lower surface 72. Preferably, it is somewhere in between the two. More preferably, it is at a distance sufficient to allow for a drop to partially form before it contacts the inner wall 76. Typically this can be from about 0.1 R (where R=radius of the pendant drop formed) to about 0.95 R. Alternatively, it can be from about 0.05 R to less than about 1 R wherein R is the radius of the filter plate or collection plate well In this way, the device 60 (formed of the spout 68, ring inner wall 70, lower surface 72 and inner well wall 76) are clear of each other and not subject to damage and the liquid from the spout 68 is effectively pulled into the collection plate well 76.

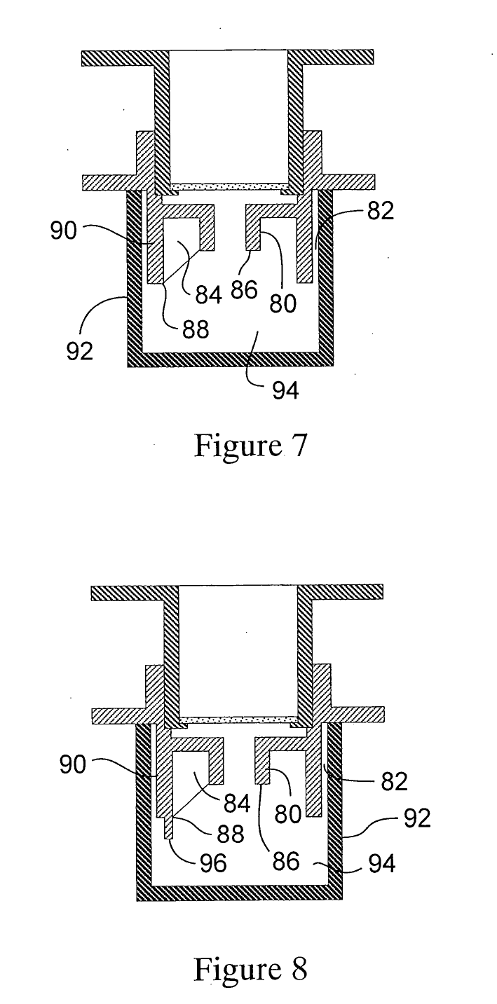

FIG. 7 shows another embodiment of the present invention. Here the spout 80 is centrally located with the protection ring 82. A mechanical device 84, in this embodiment in the form of a downwardly sloping ramp, extends from the outer edge 86 of the spout 80 to the inner wall 88 of the ring 82. As in the embodiment of FIG. 6, the outer wall 90 of the ring 82 is spaced apart from the inner wall 92 of the collection plate 94 so the liquid travels along the adjacent surfaces (86,84,88,92) from the spout 80 to the well 94.

FIG. 8 is a variation on that of FIG. 7. The addition of a drop concentrator 96 at the bottom of the device 84 allows any liquid to flow to the concentrator 96 where it forms a pendant drop and either touches the inner side wall 92 and then continues to travel to the bottom of the well 94 or if the drop radius is smaller than the distance between the well's inner wall 92 and concentrator 96 to then allow it to simply drop into the well 94.

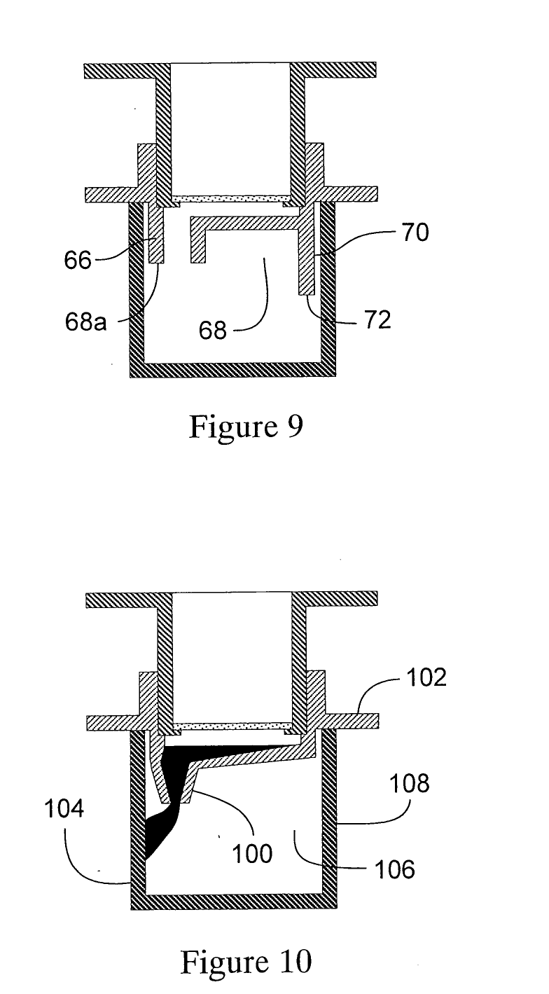

FIG. 9 shows a variation on the embodiment of FIG. 6 in which a portion of the protection ring 68A adjacent the spout 66 has been removed. In this embodiment, the drop that forms on the spout 66 transfers directly to the inner wall of the well rather than flowing down the ring wall reforming as a drop and then transferring to the wall as in embodiment of FIG. 6.

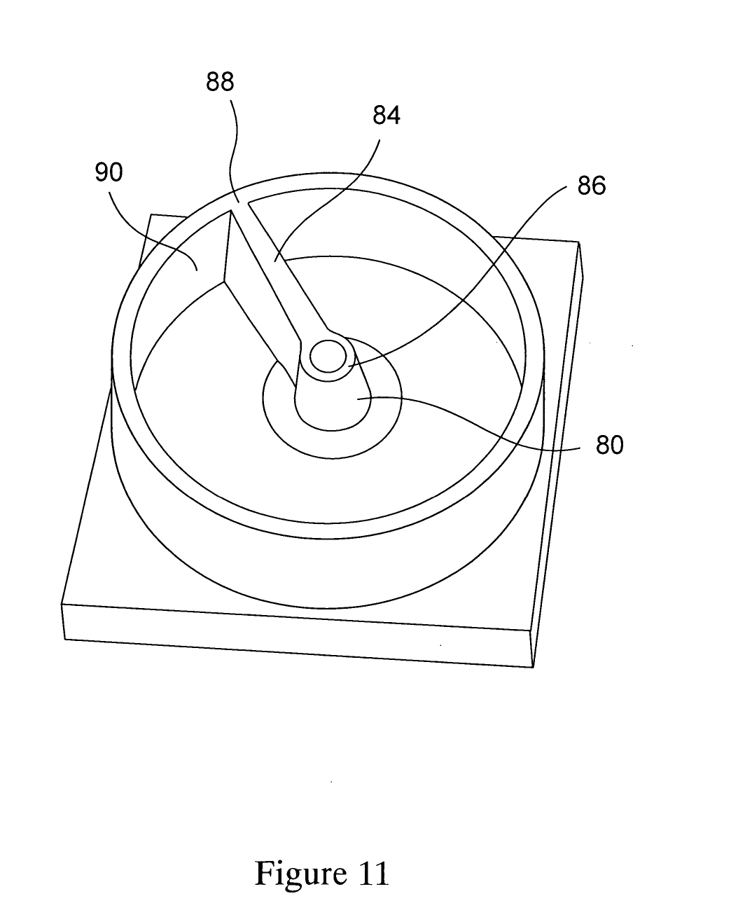

FIG. 10 shows the use of an offset spout 100 in the underdrain 102 so that it is closer to one wall 104 of the collection plate well 106 than the other wall 108. In this embodiment, the spout 100 is located near the wall 104 such that it is spaced from about 0.05 R to about less than (<) 1.0 R (where R is the radius of the pendant drop formed by the spout selected) from the wall 104. Alternatively, by another method, this can be from about 0.05 R to about less about 1 R where R is the radius of the filter plate well or the collection plate well. In this embodiment any drop that is partially formed on the spout 100 contacts the wall 104 and then travels down the wall 104 into the collection plate well 106.

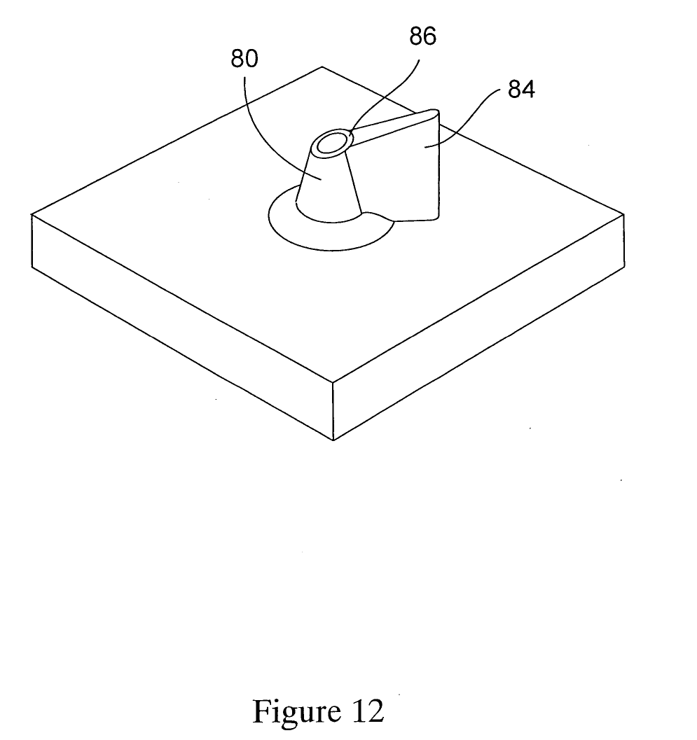

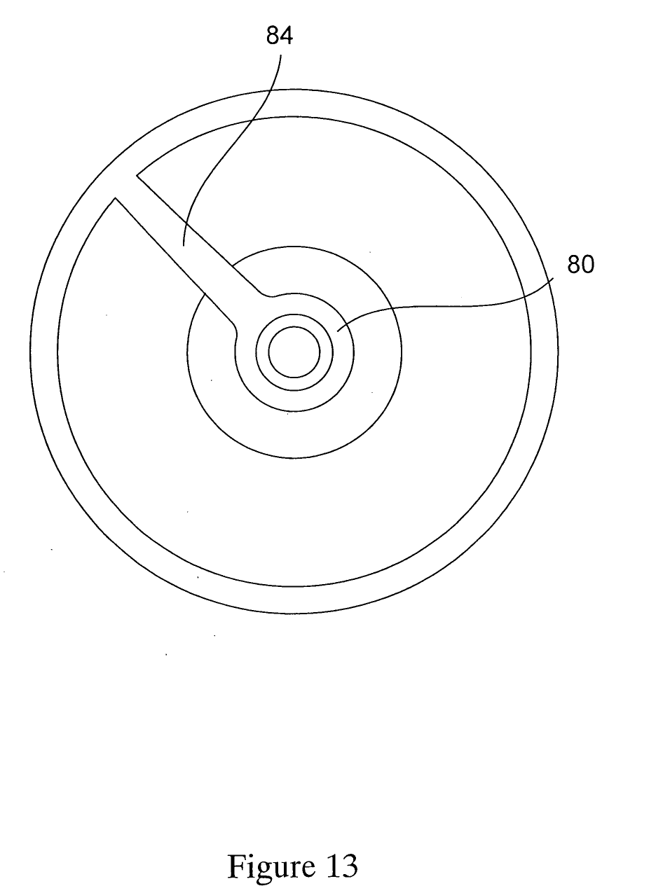

FIG. 11 shows a bottom 3D view of the spout in the protector ring of FIG. 7. FIG. 12 shows the ramp 84 on the spout 80 without any ring 82 in 3D view. While not shown in this embodiment, a concentrator may also be used on the lowermost portion of the ramp to help recollect and transfer the fluid. FIG. 13 shows a bottom up view of the spout of FIG. 7.

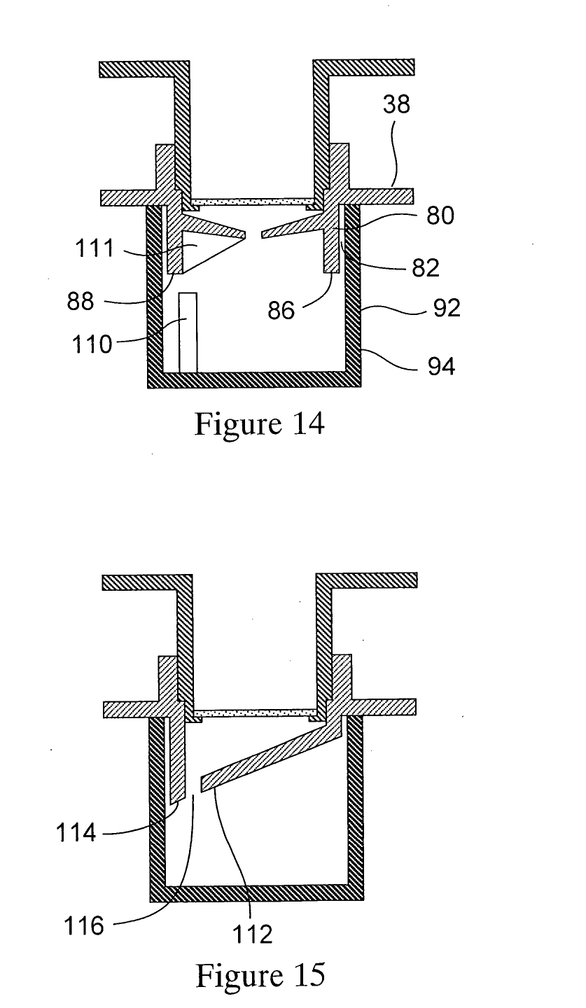

FIG. 14 shows a cross sectional view of another embodiment that uses a mechanical device 110 and 111 in both the collection device 94 and the underdrain 38. In this embodiment as shown one can use a post 110 similar to that described in FIG. 3 within the collection device and a ramp 111 similar to that of FIG. 7. In this manner one can transfer fluid from the device of the underdrain to the device of the collection device.

FIG. 15 shows another embodiment of the present invention in which the outer and inner bottom surfaces 112 of the underdrain 114 are both sloped in the same direction toward one end of the inner wall of the collection device. Also note that the opening does not have to terminate in a spout in any of the embodiments of the present invention.

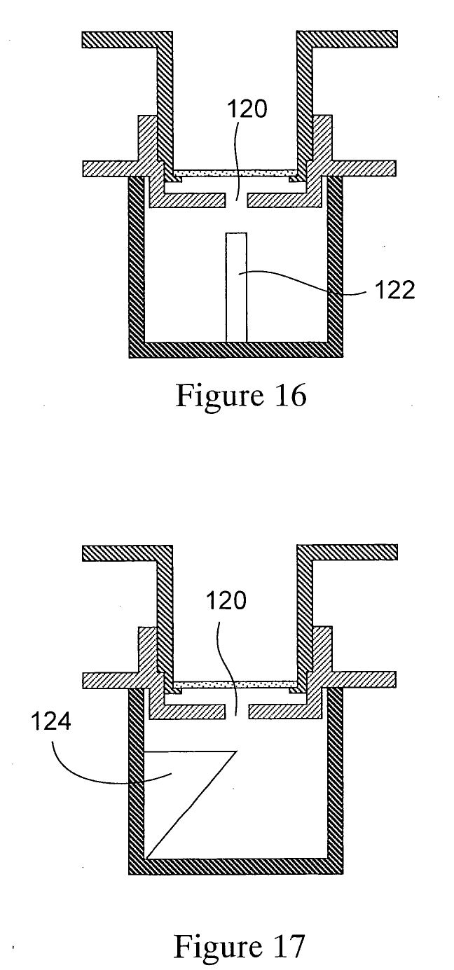

In this embodiment, the opening is simply formed in the bottom surface 112 of the underdrain 114. The opening may be a round, oval or square hole or it may be a slit or a series of holes or slits. The size, shape and number is not important so long as the device functions as is intended. As shown it is located at the lowermost point of the underdrain 114 which is preferred as it removes the maximum amount of fluid. However, other locations and designs can also be used to accomplish the same task. FIGS. 16 and 17 show similar simple openings 120 in embodiments that use a post 122 or a ramp 124 or combinations and variations of them as discussed above.

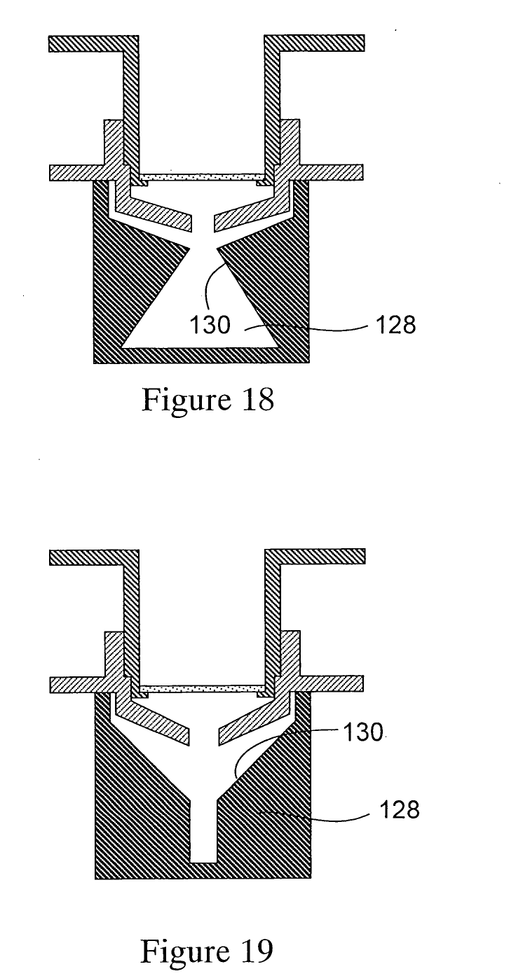

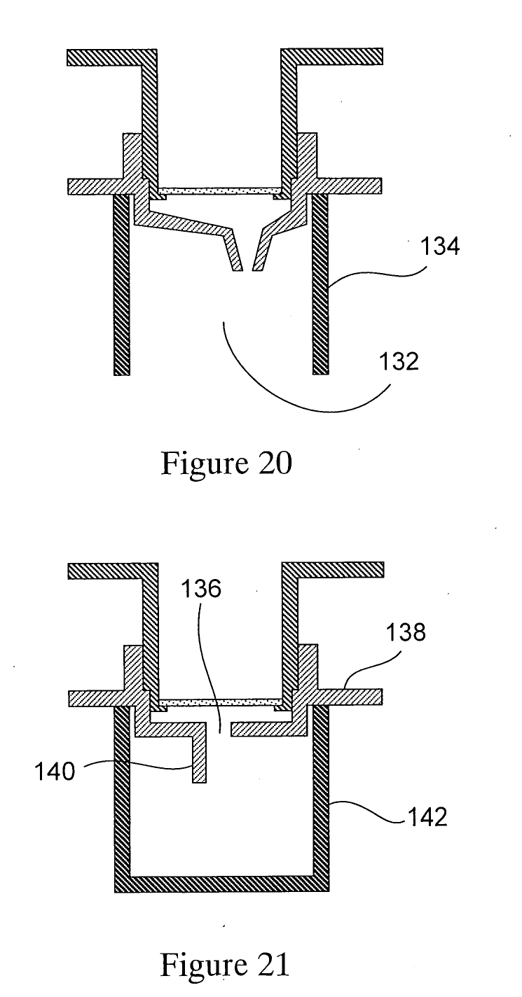

FIG. 18 shows an embodiment in which the device 128 is a constricted and outwardly sloping surface 130 formed in one or more of the inner walls of the collection device. The taper 130 acts as the device for drawing off the pendant drop. It may extend all the way down the length of the inner wall as shown or it may terminate short of that as desired. As shown in FIG. 19 one may also use an inwardly tapered well. In either embodiment of FIGS. 18 and 19, the opening may be centered and the taper adjusted so as to be near the opening on at least one side or if desired the opening may be offcenter toward the taper.

FIG. 20 shows the use of an open bottom 132 on a collection device 134. Such devices can be in the form of a collection plate with individual wells and can be placed into a vacuum manifold. The collected filtrate can either go to waste or can be collected communally for further use.

FIG. 21 shows an opening 136 in the underdrain 138 that has a device 140 in the form of a downwardly directed extension. This may be used to allow any drop to contact the floor of collection device if one is present (as shown) or the manifold floor or the liquid already within the collection device. It has been found that when this device is used, even if substantial portion of it is located within the filtrate that the drop transfers easily and quickly and when the filter plate is removed, no pendant drop forms on the device.

The underdrain can be an integral component of the filter plate, having been molded as part of the plate, overmolded on to a preformed plate or preformed separately and bonded to a preformed plate. Alternatively, it can be releasably attached to the bottom of a preexisting plate.

The collection plate or underdrain can be formed with the mechanical device or fixture as part of it such as by injection molding the fixture into/onto the collection plate or underdrain as it is being formed.

Alternatively, the fixture can be added separately and after the collection plate or underdrain has been made, by overmolding, gluing or welding (ultrasonic or RF welding preferred) the fixture in place. In these instances it may be advantageous to form some type of alignment guide in the collection well or underdrain when it is formed. For example for a post in a collection plate, it may be advantageous to form a alignment hole in the bottom of the wells so that a post can be placed into it and then welded or bonded in place. Likewise on a rib or ramp formed on the sidewall of the well of a collection plate, it may be advantageous to form a crease or groove into which the rib or ramp can be formed or bonded or welded.

Preferably the fixture is made of the same material as that of the part of the system to which it is formed or attached. If dissimilar materials are used, one would need to ensure that a suitable bond or weld can be formed between the materials.

Suitable polymers which can be used to form the underdrain, collection plate and the filter plate include but are not limited to polycarbonates, polyesters, nylons, PTFE resins and other fluoropolymers, acrylic and methacrylic resins and copolymers, polysulphones, polyethersulphones, polyarylsulphones, polystyrenes, polyvinyl chlorides, chlorinated polyvinyl chlorides, ABS and its alloys and blends, polyolefins, preferably polyethylenes such as linear low density polyethylene, low density polyethylene, high density polyethylene, and ultrahigh molecular weight polyethylene and copolymers thereof, polypropylene and copolymers thereof and metallocene generated polyolefins.

Preferred polymers are polyolefins, in particular polyethylenes and their copolymers, polystyrenes and polycarbonates.

The underdrain, collection device and filter plate may be made of the same polymer or different polymers as desired.

Likewise the polymers may be clear or rendered optically opaque or light impermeable. When using opaque or light impermeable polymers, it is preferred that their use be limited to the side walls so that one may use optical scanners or readers on the bottom portion to read various characteristics of the retentate. When the filter is heat bonded to the underdrain, it is preferred to use polyolefins due to their relatively low melting point and ability to form a good seal between the device and the filter.

One may use one or more filters in a given device. Typically, one filter layer is used, although some applications may require two or more filter layers (sometimes as a prefilter or to perform other desired functions). The filter(s) may be of any variety commonly used in filtering biological specimens including but not limited to microporous membranes, ultrafiltration membranes, coarse filters such as fibrous mats, nanofiltration membranes, or reverse osmosis membranes. Preferably microporous membranes, ultrafiltration membranes, coarse filters, or nanofiltration membranes are used. Even more preferably, microporous and ultrafiltration membranes and coarse filters are used.

Representative suitable microporous membranes include nitrocellulose, cellulose acetate, polysulphones including polyethersulphone and polyarylsulphones, polyvinylidene fluoride, polyolefins such as ultrahigh molecular weight polyethylene, low density polyethylene and polypropylene, nylon and other polyamides, PTFE, thermoplastic fluorinated polymers such as poly (TFE-co-PFAVE), polycarbonates or particle filled membranes such as EMPORE® membranes available from 3M of Minneapolis, Minn. Such membranes are well known in the art and are commercially available from a variety of sources including Millipore Corporation of Billerica, Mass. If desired these membranes may have been treated to render them hydrophilic. Such techniques are well known and include but are not limited to grafting, crosslinking or simply polymerizing hydrophilic materials or coatings to the surfaces of the membranes.

Representative ultrafiltration or nanofiltration membranes include polysulphones, including polyethersulphone and polyarylsulphones, polyvinylidene fluoride, and cellulose. These membranes typically include a support layer that is generally formed of a highly porous structure. Typical materials for these support layers include various non-woven materials such as spun bounded polyethylene or polypropylene, or glass or microporous materials formed of the same or different polymer as the membrane itself. Such membranes are well known in the art, and are commercially available from a variety of sources such as Millipore Corporation of Billerica, Mass.

Suitable coarse filters include glass mats, glass fibers, fibrous mats of cellulosic material or plastic, filter papers such as DEAE paper or pH paper and the like.

As described above, with the use of a plurality of wells, it is important that when wells are used in both the filter plate and collection device that the wells of the first plate register with the wells of the second plate. Typically multiple well plates have been made in formats containing 6, 96, 384 or up to 1536 wells and above. The number of wells used is not critical to the invention. This invention may be used with any multiple number of wells provided that the filter is capable of being secured to the filter plate in a manner which forms a liquid tight seal between the periphery of the filter and the end of the wells of the plate. The wells are typically arranged in mutually perpendicular rows. For example, a 96 well plate will have 8 rows of 12 wells. Each of the 8 rows is parallel and spaced apart from each other. Likewise, each of the 12 wells in a row is spaced apart from each other and is in parallel with the wells in the adjacent rows. A plate containing 1536 wells typically has 128 rows of 192 wells.

The wells are typically of round (generally on the 96 well devices) or square (generally on the 384 and 1536 well devices) shape although they may be any shape that can be used in such devices such as oval, teardrop, triangular or various polygonal shapes.

Any method which seals the membrane within the well of the plate (in the single plate design) and on or in the well of the bottom plate (in the two plate design) such that all fluid within the well must pass through the filter before leaving the well through the bottom opening will be useful in this invention.

One method of forming such a device is to form a single plate of a suitable plastic as described above and use a mechanical seal between the well wall and the filter. In this embodiment, there is an undercut formed around the periphery of the inner wall of the well. The filter is sized so as to fit within the undercut portion of the well. The filter is placed within the well. Optionally, a sealing gasket is applied on top of the filter within the undercut. This sealing gasket applies pressure to the filter and ensures that all the fluid must pass through the filter thereby eliminating any leakage or bypass of the filter by the fluid. This gasket may be in the form of a preformed gasket such as an O-ring. Alternatively, a gasket formed of a molten or liquid material may be cast into the undercut to seal the filter in place. An example of a molten material suitable for this embodiment, are any of the well-known hot melt materials such as polyethylene or polypropylene or ethylene vinyl acetate copolymers. A liquid gasket may be formed of any curable rubber or polymer such as an epoxy, urethane or synthetic rubber.

Another method of forming such a device is to use an adhesive to bond and seal the edge of the filter within the well such as all fluid must pass through the filter before entering the opening in the bottom of the well. Adhesive may be either molten or curable as discussed above.

A further method is to use a thermal bond to secure the filter to the well. In this embodiment, a filter sealing device which has a sealing surface which is heated is brought into contact with the upper filter surface and transfer its thermal energy to the surrounding filter and well material. The energy causes either the filter material or the well materials or both to soften and or melt and fuse together forming an integral, fluid tight seal. This process may be used when either the filter material or the well material or both are formed of a thermoplastic material. It is preferred that the well as well as at least a portion of the filter material adjacent the downstream side of the filter be formed of a thermoplastic material. The sealing surface is only a portion of the filter surface and is a continuous structure so that a ring or peripheral area of the filter is sealed to the well so as to form a liquid tight seal between the filter, the well and the opening in the bottom of the well.

1) A collection device containing one or more wells, each of the one or more wells having an open top and the one or more wells each containing a mechanical device for directing the fluid into the collection device well.

2) The plate of claim 1 wherein the device for directing fluid is one or more fixtures formed in each of the collection device wells.

3) The plate of claim 1 wherein the device for directing fluid is one or more fixtures formed in each of the collection device and the fixture is in the form of one or more posts arising from the bottom of each well of the collection device.

4) The plate of claim 1 wherein the device for directing fluid is one or more fixtures formed in each of the collection device wells and the fixture is in the form of one or more posts arising from the bottom of each well of the collection plate and wherein the height of the one or more posts is less than the depth of the well.

5) The plate of claim 1 wherein the device for directing fluid is one or more fixtures formed in each of the collection device wells and the fixture is in the form of one or more ramps arising from a wall of each well of the collection device.

6) The plate of claim 1 wherein the device for directing fluid is one or more fixtures formed in each of the collection device wells and the fixture is in the form of one or more posts extending from one or more walls of the one or more wells of the collection device.

7) The plate of claim 1 wherein the device for directing fluid is one or more fixtures formed in each of the collection device wells and the fixture is in the form of one or more ramps arising from a wall of each well of the collection device and wherein the height of the one or more ramps is less than the depth of the well.

8) The plate of claim 1 wherein the device for directing fluid is a fixture formed in each of the collection plate wells and the fixture is in the form of a rib formed adjacent a portion of the inner wall of the collection plate well.

9) An underdrain for attachment to a filter plate, the underdrain containing one or more chambers, each of the one or more chambers having an open top and a substantially closed bottom, each of the substantially closed bottoms having an opening to the outside environment in a lower surface of the underdrain and the openings each having a mechanical device formed adjacent the openings for directing fluid collected on the opening.

10) The underdrain of claim 9 wherein the device for directing fluid is a combination of a spout and a spout protector ring wherein the spout is located adjacent a wall of the ring.

11) The underdrain of claim 9 wherein the device for directing fluid is a combination of a spout that is offset from the centerline of the underdrain.

12) The underdrain of claim 9 wherein the device for directing fluid is in the form of a ramp extending downwardly and away from the opening.

13) The underdrain of claim 9 wherein the opening has a spout and device for directing fluid is in the form of a ramp extending downwardly and away from the spout.

14) The underdrain of claim 9 wherein the opening has a spout surrounded by a spout protection ring and device for directing fluid is in the form of a ramp extending downwardly and away from the spout to an inner wall of the protector ring.

15) The underdrain of claim 9 wherein the device for directing fluid is in the form of a ramp extending downwardly and away from the opening and the ramp terminating at its lowest and farthest point from the opening in a drop concentrator.

16) The underdrain of claim 9 wherein the opening is in the form of a spout and device for directing fluid is a combination of the spout and a spout protector ring wherein the spout is offset in the ring so as to be closer to one wall of the ring than another and the area of the ring adjacent the spout has been removed.

17) The underdrain of claim 9 wherein the opening is in the form of a spout and device for directing fluid is a combination of the spout and a spout protector ring formed of two or more sections wherein the spout is offset in the ring so as to be closer to one wall of the ring than another and the area of the ring adjacent the spout has been removed.

18) A multiple well plate filtration system comprising a filter plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface, a bottom surface and a thickness in between, the top surface of the underdrain attached to the bottom of the plate, the underdrain having a series of chambers formed in its thickness that register and mate with the bottom of the plurality of wells of the plate so as to ensure that fluid passing through the filter of a selected well enters only the respective chamber of the underdrain, each chamber having an opening through the bottom surface of the underdrain to an outside environment, a collection device located below the underdrain, the collection device having an open top, a bottom, a thickness therebetween and one or more wells extending through the thickness, the one or more wells of the collection device being in alignment with the wells of the filter plate and its associated underdrain chamber and a mechanical device for directing the fluid from the opening of the underdrain into the collection plate well.

19) The system of claim 18 wherein the device for directing fluid is one or more fixtures formed in each of the collection device wells.

20) The system of claim 18 wherein the device for directing fluid is one or more fixtures formed in each of the collection device and the fixture is in the form of one or more posts.

21) The system of claim 18 wherein the means for directing fluid is one or more fixtures formed in each of the collection device and the fixture is in the form of one or more posts arising from the bottom of the collection device and wherein the height of the one or more posts is less than the depth of the one or more wells of the collection device.

22) The system of claim 18 wherein the means for directing fluid is one or more fixtures formed in the collection device and the fixture is in the form of one or more posts f, the height of the one or more posts is less than the thickness of the collection device and the one or more posts are offset from a centerpoint of each opening of the underdrain.

23) The system of claim 18 wherein the means for directing fluid is one or more fixtures formed in each of the collection device and the fixture is in the form of one or more ramps arising from one or more walls of the collection device.

24) The system of claim 18 wherein the means for directing fluid is one or more fixtures formed in each of the collection device and the fixture is in the form of one or more ramps arising from one or more walls of the collection device and wherein the height of the one or more ramps is less than the thickness of the collection device.

25) The system of claim 18 wherein the means for directing fluid is a fixture formed in the one or more wells of the collection device and the fixture is in the form of a rib formed adjacent a portion of one or more of the inner walls of the collection device.

26) The system of claim 18 were in the collection device is a collection plate having a series of wells corresponding in location and number to the wells of the filter plate and the wells of the collection plate have closed bottoms.

27) The system of claim 18 were in the collection device is a collection plate having a series of wells corresponding in location and number to the wells of the filter plate and the wells of the collection plate have open bottoms.

28) A multiple well plate filtration system comprising a filter plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface, a bottom surface and a thickness in between, the top surface of the underdrain attached to the bottom of the plate, the underdrain having a series of chambers formed in its thickness that register and mate with the bottom of the plurality of wells of the plate so as to ensure that fluid passing the filter of a selected well enters only the respective chamber of the underdrain, each chamber having an opening through the bottom surface of the underdrain to an outside environment, a collection plate located below the underdrain, the collection plate having a top, a bottom and a thickness between the top and the bottom, a plurality of wells extending through the thickness, each well of the collection plate is in alignment with a well of the filter plate and its associated underdrain chamber and opening, wherein each well of the collection plate has a mechanical device for directing the fluid into the collection plate well from the bottom opening of the underdrain and wherein the device is in a form selected from the group consisting of one or more posts, one or more ramps, one or more ribs and combinations thereof.

29) A device for separating a liquid sample comprising:
an upper plate having at least two wells integrally connected together, each well having an upper opening and a lower opening, the lower opening being positioned on a bottom surface of the upper plate and a separation layer between located between the upper opening and the lower opening of the upper plate,
a lower collection device arranged below the upper plate, the collection device having one or more wells arranged in register with the two or more wells of the upper plate to receive liquid from the lower opening of the upper plate, wherein each opening has a mechanical device for directing the fluid into the collection device and wherein the mechanical device is in a form selected from the group consisting of one or more one or more ramps, one or more rings and combinations thereof.

30) A device for separating a liquid sample comprising:
an upper plate having at least two wells integrally connected together, each well having an upper opening and a lower opening, the lower opening being positioned on a bottom surface of the upper plate and a separation layer between located between the upper opening and the lower opening of the upper plate,
a lower collection device arranged below the upper plate, the collection device having one or more wells arranged in register with the two or more wells of the upper plate to receive liquid from the lower opening of the upper plate, wherein the bottom surface of the upper plate and the collection device contain a series of mechanical devices for directing the fluid into the collection device from each opening and wherein the mechanical devices are in a form selected from the group consisting of one or more one or more ramps, one or more ribs, one or more posts and combinations thereof.

31) A device for separating a liquid sample comprising:
an upper plate having at least two wells integrally connected together, each well having an upper opening and a lower opening, the lower opening being smaller than the upper opening and in the form of a spout, the lower opening being positioned on a bottom surface of the upper plate and a separation layer located between the upper opening and the lower opening of the upper plate,
a lower collection plate arranged below the upper plate, the collection plate having one or more wells arranged in register with the two or more wells of the upper plate to receive liquid from the spouts of the upper plate, and wherein the spouts are offset from a centerline of the well of the upper plate and adjacent an inner wall of the wells of the collection plate, wherein the spout is spaced apart from the inner wall of the collection plate by a distance of from about 0.05 R to about less than 1.0 R where R is the radius of a drop formed by the selected spout.
